(19) United States
(12) Patent Application Publication
(10) Pub. No.: US 2005/0125824 A1
(43) Pub. Date: Jun. 9, 2005

(54) Method for providing PEG channel programming

(75) Inventor: Terry S. Bienstock, Philadelphia, PA (US)

Correspondence Address: BROOKS KUSHMAN P.C., 1000 TOWN CENTER, TWENTY-SECOND FLOOR, SOUTHFIELD, MI, 48075, US

(73) Assignee: Comcast Cable Holdings, LLC, Philadelphia, PA (US)

(21) Appl. No.: 10/731,795

(22) Filed: Dec. 9, 2003

(51) Int. Cl. H04N 7/18; G06F 13/00; H04N 5/445; G06F 3/00

(52) U.S. Cl. 725/39; 725/44; 725/55

(57) ABSTRACT

A cable television network provides public, educational and governmental (PEG) programming pursuant to an agreement with the local franchising authority for a local area. A PEG channel is provided in the local area channel lineup. Backdrop programming is provided on the PEG channel. The backdrop programming is general local interest programming provided by the cable television network. When locally produced PEG programming is available and intended for local broadcast, the backdrop programming is preempted and the locally produced PEG programming is provided. In this way, locally produced PEG programming is provided against the backdrop of general local interest programming provided by the cable television network. The method for providing PEG channel programming also comprehends video on demand (VOD) and high speed data (HSD) aspects.

### BACKGROUND OF THE INVENTION

1. Field of the Invention

The invention relates to signal distribution technologies including cable television networks. The invention further relates to public, educational and governmental (PEG) channels.

2. Background Art

The typical implementation of a cable television network in a local area uses coax cable for distribution through the local neighborhoods. Local franchising authorities may require cable operators to set aside channels for public, educational or governmental (PEG) use. Local franchising authorities may also require cable operators to provide services, facilities or equipment for the PEG channels. In return, the cable operators are allowed via easements to use coax cable distribution through the local neighborhoods.

For over twenty years, local PEG channels have been available to local governments to provide a forum for people to televise viewpoints, content, events and other matters of local interest. As well, local PEG channels have been available for schools to provide educational television programming, and for local governments themselves to televise public hearings and other information of interest to local residents.

Local PEG channels, which exist due to agreement with the local franchising authority and have been used for many years, do have a significant drawback in the present implementations. The drawback is that the cable operator reserves one or more PEG channels, but there is not enough PEG content to fully utilize the reserved bandwidth. The result is an inefficient use of bandwidth. Channel space, and particularly analog channel space, is very valuable to the cable operator and is needed to launch some new products and services such as video on demand (VOD), high definition television (HDTV) and high speed data (HSD).

One existing approach to addressing this bandwidth situation is to repeatedly broadcast whatever PEG programming is available. In this way, although the same programming is shown repeatedly, at least the channel space is being used, and some viewers will benefit from the viewing flexibility provided.

Background information may be found in Fredrick M. Baumgartner, “Building ADMC's Third Party DTV Central Casting System,” presented at National Association of Broadcasters Convention 2002.

Although this existing approach is a workable approach in many situations, there is a need for an improved way to provide PEG channel programming.

### SUMMARY OF THE INVENTION

It is an object of the invention to provide an improved method for providing PEG channel programming.

In carrying out the invention, a method for use in a cable television network to provide public, educational and governmental (PEG) channel programming pursuant to an agreement with a local franchising authority for a local area is provided. The method comprises providing a PEG channel in a channel lineup for the local area in accordance with the local franchising authority agreement. The method further comprises providing backdrop programming on the PEG channel. The backdrop programming is general local interest programming provided by the cable television network. The method further comprises determining the availability of locally produced PEG programming. In the event that locally produced PEG programming is available and intended for local broadcast, the backdrop programming is preempted to provide the locally produced PEG programming on the PEG channel, thereby providing locally produced PEG programming against a backdrop of general local interest programming provided by the cable television network.

It is appreciated that the locally produced PEG programming is programming that is traditionally associated with a local PEG channel including local public access, educational access, and local governmental access programming. For example, the locally produced PEG programming may include locally produced public access shows and events, educational programs, and county, city or town meetings.

It is appreciated that the general local interest programming provided by the cable television network is programming which contains subjects of universal local interest and is provided by the cable television network as opposed to being programming that is traditionally associated with a local PEG channel. For example, the general local interest programming provided by the cable television network may include original quality programming created by a content provider which contains subjects of universal local interest. In this way, each local franchise authority receives a customized channel, just for its residents. Universal local interest means that the subjects are of interest to many localities and are complimentary to programming that is traditionally associated with a local PEG channel.

At a more detailed level, the invention comprehends the use of video on demand (VOD) to further enhance the way that PEG channel programming is provided. A VOD platform provides access to a library of locally created PEG content so that customers can access the content on demand. It is appreciated that the VOD platform may be implemented in any suitable way. In another aspect of the invention, high speed data (HSD) service may be used to further enhance the way that PEG channel programming is provided. That is, when the cable television network also provides high speed data (HSD) service, a collection of locally created content may be accessible through the HSD. HSD accessible PEG content may or may not be the same as VOD accessible PEG content. In turn, VOD accessible PEG content and HSD accessible PEG content may or may not be the same as local broadcast PEG content. In this way, the cable television network provides a cross-platform experience tailored to the needs of the local franchiser.

The advantages associated with embodiments of the invention are numerous. The invention provides locally produced PEG programming against a backdrop of general local interest programming provided by the cable television network. It is appreciated that in a large cable television network such as a hybrid fiber coax (HFC) network, there may be a number of local areas with each having its own local franchise authority agreement and PEG channel(s). Each local area then has its own locally produced PEG programming. A particular schedule of general local interest programming may be associated with any number of local areas. In this way, a group of local areas may receive the same general local interest programming, but each area receives individualized locally produced PEG programming during preemption of the general local interest programming. Put another way, a local area always has its own locally produced PEG-content, but backdrop complimentary programming may be shared by multiple local areas. Of course, preemption in a local area may be independent of preemption in any other local area.

The above object and other objects, features and advantages of the invention are readily apparent from the following detailed description of the preferred embodiment when taken in connection with the accompanying drawings.

### BRIEF DESCRIPTION OF THE DRAWINGS

FIG. 1 illustrates a signal distribution network made in accordance with the invention;

FIG. 2 illustrates an alternative signal distribution network made in accordance with the invention;

FIG. 3 is a block diagram illustrating a method of the invention;

FIG. 4 is a block diagram illustrating another method of the invention; and

FIG. 5 is a block diagram illustrating yet another method of the invention.

### DETAILED DESCRIPTION OF THE PREFERRED EMBODIMENT

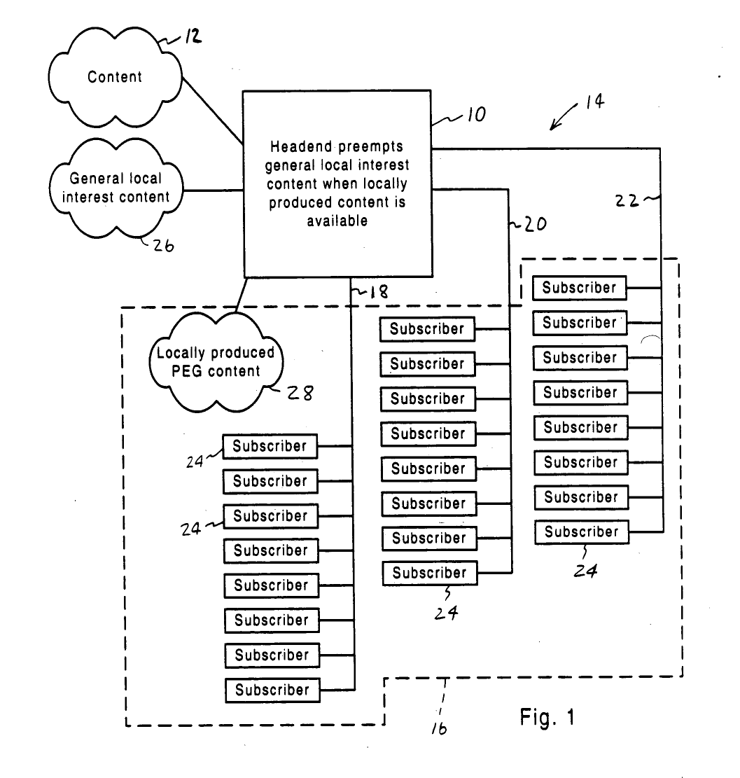

FIG. 1 illustrates signal distribution by head end 10. Head end 10 receives content from source 12. The distribution network is generally indicated at 14. Network 14 includes legs 18, 20, 22 and is shown in a simplified fashion. The final signal distribution reaches through a local area 16 to subscribers 24. Local franchising authorities in local area 16 require the cable operator to set aside channels for public, educational or governmental (PEG) use. In FIG. 1, locally produced PEG content is indicated at 28 and is provided to head end 10 for distribution on the local PEG channels. This illustrates local management of the locally produced PEG content. It is appreciated that any suitable management technique may be employed for managing the PEG content, and that embodiments of the invention are independent of any content management technique.

The locally produced PEG programming includes local public access, educational access, and local governmental access programming. For example, the locally produced PEG programming may include locally produced public access shows and events, educational programs, and county, city or town meetings. The channel lineup for local area 16 includes a PEG channel in accordance with the local franchising authority agreement. In accordance with the invention, backdrop programming is normally provided on the PEG channel. The backdrop programming is general local interest programming content from source 26 and is provided by the cable television network. In the event that locally produced PEG programming from content source 28 is available and intended for local broadcast, the backdrop programming from content source 26 is preempted to provide the locally produced PEG programming on the PEG channel. In this way, locally produced PEG programming is provided against the backdrop of general local interest programming provided by the cable television network.

The general local interest programming provided by the cable television network from content source 26 is programming which contains subjects of universal local interest and compliments the locally produced PEG content, but is provided by the cable television network as opposed to being programming that is traditionally associated with the local PEG channel. In this way, the local franchise authority for local area 16 receives a customized channel, just for its residents.

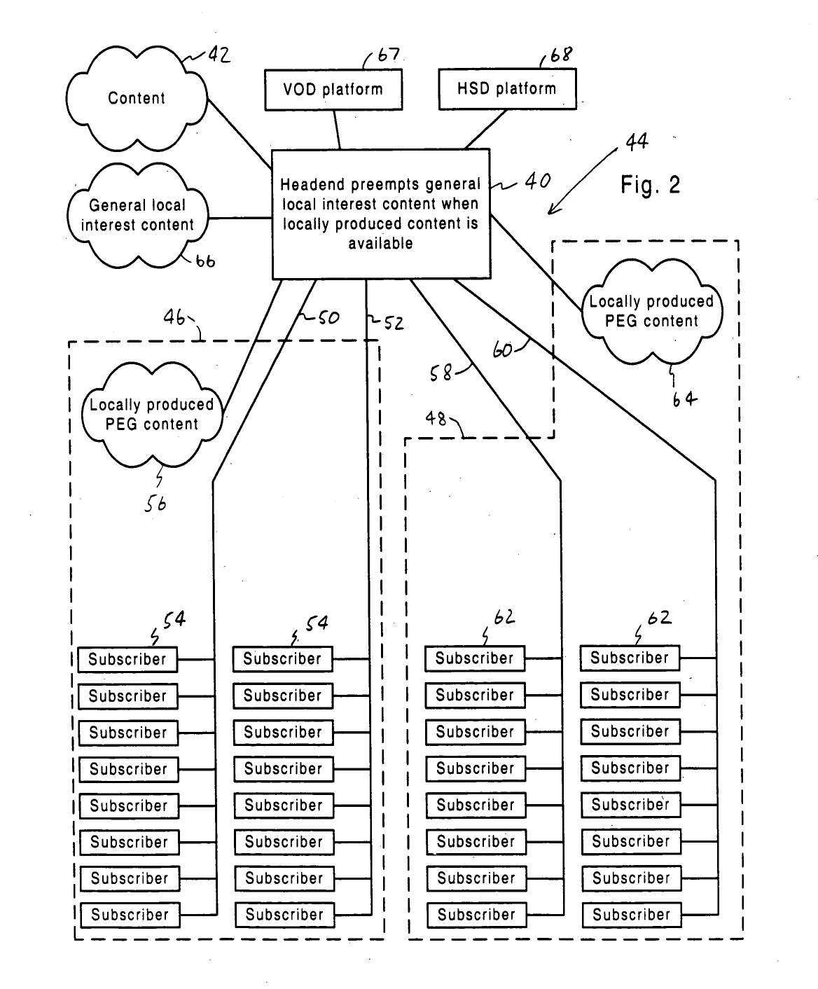

FIG. 2 illustrates an alternative signal distribution network and illustrates signal distribution by head end 40. Head end 40 receives content from source 42. The distribution network is generally indicated at 44 and distributes programming to local area 46 and local area 48. Local area 46 receives signals from distribution legs 50, 52 to provide programming to subscribers 54. The locally produced PEG content source is indicated at 56. Local area 48 receives signals from distribution legs 58, 60 to provide programming to subscribers 62. The locally produced PEG content source for area 48 is indicated at 64. In the arrangement shown in FIG. 2, each local area has its own locally produced PEG content, but the areas share the same backdrop programming from general local content source 66. In this way, both local areas receive the same general local interest programming, but each area receives individualized locally produced PEG programming during preemption of the general local interest programming.

With continuing reference to FIG. 2, a video on demand (VOD) platform 67 includes a library of locally produced PEG programming. Locally produced PEG programming may be provided on demand with VOD platform 67. VOD platform 67 may be configured such that stored locally produced PEG content is only available to subscribers in the local area where the content originated. Similarly, high speed data (HSD) platform 68 may also be used to further enhance the way that PEG channel programming is provided. When high speed data (HSD) service is present in the cable television network, a library or collection of locally produced PEG programming may be located in the HSD platform. In this way, locally produced PEG programming may be provided on demand with the HSD platform 68. Locally produced PEG content available from HSD platform 68 may be limited to subscribers where the content originated. Further, HSD accessible content may or may not be the same as VOD accessible content. Still further, VOD accessible content and HSD accessible content may or may not be the same as local broadcast content. In this way, the cable television network provides a cross-platform experience tailored to the needs of the local franchiser.

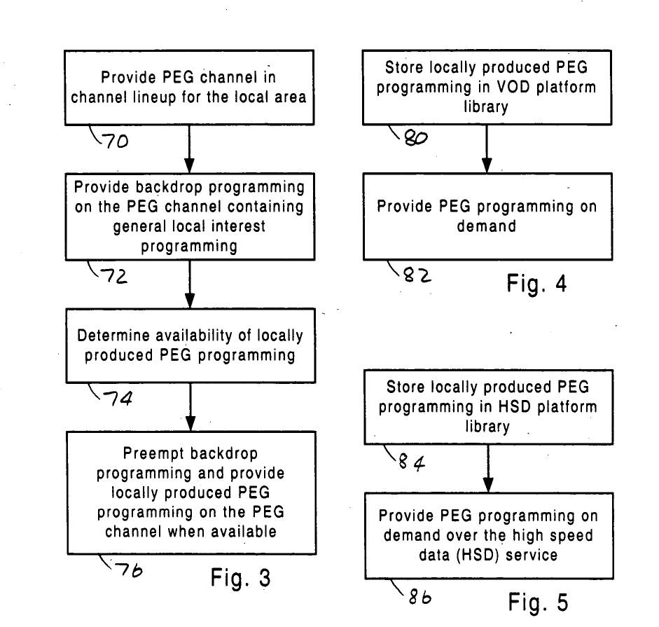

FIG. 3 illustrates a method of the invention. At block 70, a PEG channel is provided in the channel lineup for a local area. At block 72, backdrop programming containing general local interest programming is provided on the PEG channel. At block 74, the availability of locally produced PEG programming is determined. At block 76, backdrop programming is preempted by locally produced PEG programming on the PEG channel when locally produced PEG programming is available and intended for local broadcast. It is appreciated that multiple local areas may share the same backdrop programming in certain situations.

FIG. 4 illustrates a VOD aspect of the invention. At block 80, locally produced PEG programming is stored in a VOD platform library. At block 82, the PEG programming is provided on demand.

FIG. 5 illustrates an HSD aspect of the invention. At block 84, locally produced PEG programming is stored in an HSD platform library. At block 86, the PEG programming is provided on demand over the high speed data (HSD) service.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A method for use in a cable television network to provide public, educational and governmental (PEG) programming pursuant to an agreement with a local franchising authority for a local area, the method comprising:
providing a PEG channel in a channel lineup for the local area in accordance with the local franchising authority agreement;
providing backdrop programming on the PEG channel, the backdrop programming being general local interest programming provided by the cable television network;
determining an availability of locally produced PEG programming; and
when locally produced PEG programming is available and intended for local broadcast, preempting the backdrop programming and providing the locally produced PEG programming on the PEG channel thereby providing locally produced PEG programming against a backdrop of general local interest programming provided by the cable television network.

2. The method of claim 1 wherein the locally produced PEG programming is created via local public access to the cable television network.

3. The method of claim 1 wherein the locally produced PEG programming is created via educational access to the cable television network.

4. The method of claim 1 wherein the locally produced PEG programming is created via local governmental access to the cable television network.

5. The method of claim 1 wherein the cable television network encompasses a plurality of local areas, wherein (PEG) programming is provided on a PEG channel to a local area pursuant to an agreement with a corresponding local franchising authority, and wherein the same general local interest programming is provided on the PEG channels for multiple local areas.

6. The method of claim 1 wherein the cable television network includes a video on demand (VOD) platform, the VOD platform including a library of locally produced PEG programming, the method further comprising:
providing locally produced PEG programming on demand with the VOD platform.

7. The method of claim 1 wherein the cable television network includes a high speed data (HSD) platform, the HSD platform including a library of locally produced PEG programming, the method further comprising:
providing locally produced PEG programming on demand with the HSD platform.

8. A method for use in a cable television network to provide public, educational and governmental (PEG) programming pursuant to agreements with local franchising authorities for local areas, the method comprising:
providing a PEG channel in the channel lineup for each local area as required by the corresponding local franchising authority agreement;
providing backdrop programming on each PEG channel, the backdrop programming being general local interest programming provided by the cable television network;
for each local area having a PEG channel, determining an availability of locally produced PEG programming; and
when locally produced PEG programming is available and intended for local broadcast in a particular local area having a PEG channel, preempting the backdrop programming and providing the locally produced PEG programming on the PEG channel in the particular local area thereby providing locally produced PEG programming against a backdrop of general local interest programming provided by the cable television network.

9. The method of claim 8 wherein the locally produced PEG programming is created via local public access to the cable television network.

10. The method of claim 8 wherein the locally produced PEG programming is created via educational access to the cable television network.

11. The method of claim 8 wherein the locally produced PEG programming is created via local governmental access to the cable television network.

12. The method of claim 8 wherein the same general local interest programming is provided on the PEG channels for multiple local areas.

13. The method of claim 8 wherein the cable television network includes a video on demand (VOD) platform, the VOD platform including a library of locally produced PEG programming, the method further comprising:
providing locally produced PEG programming on demand with the VOD platform.

14. The method of claim 8 wherein the cable television network includes a high speed data (HSD) platform, the HSD platform including a library of locally produced PEG programming, the method further comprising:
providing locally produced PEG programming on demand with the HSD platform.
